(19) United States
(12) Patent Application Publication
(10) Pub. No.: US 2018/0200722 A1
(43) Pub. Date: Jul. 19, 2018

(54) ROTOR FOR AN IMPACT CRUSHER

(71) Applicants: THYSSENKRUPP INDUSTRIAL SOLUTIONS AG, Essen (DE); thyssenkrupp AG, Essen (DE)

(72) Inventors: Daniel STEINSTRÄTER, Beckum (DE); Khezr SHARIATZADEH, Dortmund (DE)

(73) Assignees: THYSSENKRUPP INDUSTRIAL SOLUTIONS AG, Essen (DE); thyssenkrupp AG, Essen (DE)

(21) Appl. No.: 15/743,598

(22) PCT Filed: Jul. 22, 2016
(86) PCT No.: PCT/EP2016/067548

§ 371 Date: Jan. 10, 2018

(30) Foreign Application Priority Data
Jul. 23, 2015 (DE) 102015213963.8

(51) Int. Cl. B02C 13/28; B02C 13/06

(52) U.S. Cl. CPC B02C 13/2804; B02C 13/06

(57) ABSTRACT

A rotor of an impact crusher may include a crushing roll body that can be rotated about a center line of the crushing roll body. The crushing roll body may include at least one radial recess. The rotor may further include at least one blow bar positioned in the recess of the crushing roll body. Still further, the rotor may include at least one chock positioned in the recess between the blow bar and the crushing roll body. The chock may have at least one receiving region, in which an application means for moving the chock in a radially-inward direction is positioned.

The invention relates to a rotor of an impact crusher.

Impact crushers are generally used to break down materials such as limestone, marl, clay, rubble or similar mineral materials. Known impact crushers have a rotor with blow bars spaced uniformly apart. The rotor interacts with a second rotor rotating in the opposite direction or with impact elements arranged to the side of the rotor, for example, in order to break down the material.

In the case of known impact crushers, the blow bars are each wedged, e.g. hydraulically, by means of a chock in a recess in the crushing roll body. The blow bars of such an impact crusher are subject to severe wear and require regular maintenance. In the case of wear, the blow bar of known impact crushers is either completely replaced, radially offset or turned around, with the result that the opposite end of the blow bar is subject to wear. An impact crusher of this kind is known from DE3521588 A1, for example.

During the operation of the impact crusher, high centrifugal forces and vibrations act on the blow bars, often leading to jamming of the blow bars and of the chocks in the crushing roll body. To release the blow bars, it is then necessary for a worker to climb onto the rotor of the impact crusher and to release the jammed chocks using a sledgehammer, for example. This procedure involves a high risk of injury to the worker. Moreover, it is necessary to open the housing of the impact crusher in order to climb onto the rotor. Opening the housing is very time-consuming and results in long downtimes of the impact crusher.

On this basis, it is the object of the present invention to provide a rotor for an impact crusher which overcomes the abovementioned disadvantages and offers a way of releasing jamming of the blow bars in a simple manner, wherein long downtimes of the impact crusher are simultaneously avoided.

According to the invention, this object is achieved by a rotor for an impact crusher having the features of independent device claim 1. Advantageous developments will become apparent from the dependent claims.

The terms “radial direction”, “radially”, “axial direction” and “axially” should be understood with reference to the crushing roll body.

According to a first aspect, a rotor of an impact crusher comprises a crushing roll body that can be rotated about the center line thereof and has at least one radial recess, at least one blow bar arranged in a respective recess of the crushing roll body, and at least one chock arranged in the recess between the blow bar and the crushing roll body, wherein the chock has at least one receiving region, in which an application means for moving the chock in the radially inward direction is arranged. “Radially inward” should be understood to mean the movement of the chock in the radial direction toward the center line of the rotor.

The crushing roll body is of substantially cylindrical design and, during the operation of the impact crusher, rotates about its center line. The impact crusher preferably has a plurality of blow bars, which are mounted on the circumference of the crushing roll body at a uniform spacing with respect to one another. On the one hand, the crushing roll body of the impact crusher has the function of holding the blow bars and, on the other hand, that of transmitting the torque from the rotor shaft passing through the crushing roll body to the blow bars in order to apply the required crushing force. The blow bars are each arranged in a recess in the crushing roll body, wherein they project by a predetermined height above the outer circumference of the crushing roll body. The chock is of substantially wedge-shaped design, wherein the wedge angle is preferably open in the radially inward direction. For example, the chock has a first and a second chock, which are preferably arranged adjacent to one another in the axial direction.

An application means in a receiving region of the chock for moving the chock inward in the radial direction makes it possible to release the chock between the blow bar and the crushing roll body. Known impact crushers have just one means for applying a force to the chock, e.g. a hydraulic cylinder, outward in the radial direction, and these cannot achieve release of the jamming of the chock.

According to a first embodiment, the application means is designed in such a way that, when the application means is moved in the axial direction along the chock, it applies a radially inward force to the chock. In particular, the application means is designed in such a way that it redirects a force applied in the axial direction in a radial direction, with the result that the chock is moved in the radial direction. This enables the force for releasing the chock to be applied axially to the crushing roll body, e.g. laterally with respect to the latter. It is not necessary to directly apply a force to the chock in the radial direction. This avoids laborious opening of a housing mounted around the rotor in order to climb onto the crushing roll body and apply a radial force to the chock. The provision of application means of this kind therefore allows a considerable time-saving over known impact crushers.

According to another embodiment, the application means is of at least partially wedge-shaped design. The wedge shape of the application means makes it possible to convert a force in the axial direction into a force in the radial direction in a simple manner, with the result that the chock moves inward in the radial direction. In particular, the wedge angle of the application means is formed in the axial direction. In particular, the rotor has one or two chocks, which are arranged adjacent to one another in the axial direction and each have an application means. The chocks with the respective application means are preferably symmetrical with respect to one another.

According to another embodiment, the receiving region extends in the axial direction along the chock. For example, the receiving region is a recess in the chock, which extends along the length of the chock. The receiving region is preferably formed on the side face of the chock which faces in the direction of rotation of the rotor, wherein the application means is arranged therein in such a way that it is connected to the chock and to the crushing roll body.

According to another embodiment, the application means extends in the axial direction. In particular, the application means is of beam-shaped design and has a rectangular cross section.

According to another embodiment, the application means rests against the crushing roll body and the chock. This enables the chock to be moved relative to the crushing roll body by means of the application means.

According to another embodiment, the receiving region has at least one contact surface, against which the application means rests and wherein the contact surface forms an angle of about 5-20°, preferably 5-10°, in particular 8°, to the axial direction, at least in some region or regions. In particular, the contact surface faces outward in the radial direction and, in particular, extends over the entire length of the chock. A contact surface, which forms an above-described angle to the axial direction, has proven particularly advantageous since redirection of the axial force into a radial force can be achieved in a particularly simple manner by means of an angle of about 5-20°, preferably 5-10°, in particular 8°.

According to another embodiment, the receiving region comprises at least one projection on the chock, on which the at least one contact surface is arranged. The at least one projection is preferably formed on the side face of the chock which faces in the direction of rotation of the rotor. In particular, the side face of the projection which faces in the direction of rotation of the rotor forms a wedge shape with the opposite side face facing counter to the direction of rotation.

According to another embodiment, the chock has a wedge angle of 5-30°, preferably 10-20°, in particular 14°. In particular, the side face of the chock which rests against the blow bar extends in the radial direction, and the opposite side face, which rests against the crushing roll body, has an angle of 5-30°, preferably 10-20°, in particular 14°, to the radial direction.

According to another embodiment, an actuating element for moving the application means in the axial direction is mounted on the application means. According to another embodiment, the actuating element is of mechanical, electrical or hydraulic design. For example, the actuating element comprises an adapter, via which impacts are introduced into the application means in the axial direction. The actuating element is preferably an electric motor or a hydraulic cylinder, which are connected to the application means by mechanical elements such as gearwheels, for example. An actuating element of this kind allows simple, in particular automatic, movement of the application means, thus enabling the chock to be released from a jam in a simple manner.

According to another embodiment, the blow bar has a recess which is, in particular, trapezoidal, and the crushing roll body has a projection which is, in particular, trapezoidal and which rests at least partially in the recess. In particular, the recess extends along the length of the blow bar in the axial direction and allows radial fixing of the blow bar in the recess of the crushing roll body. In particular, the projection does not fill the entire recess in the blow bar. The recess and the projection are of rectangular or round design, for example.

According to another embodiment, a supporting device is provided, which has at least one support bar, in particular two support bars, which is arranged in the recess adjacent to the projection in order to fix the blow bar in the radial direction. In particular, the support bar extends in the axial direction along the blow bar. A supporting device of this kind allows reliable fixing of the blow bar in different positions in the crushing roll body. If the supporting device is removed completely or partially from the recess, the blow bar can accordingly be moved in the radial direction. The supporting device is then arranged completely or partially in the recess, thus preventing further radial movement of the blow bar.

### DESCRIPTION OF THE DRAWINGS

The invention is explained in greater detail below by means of an illustrative embodiment with reference to the attached figures.

FIG. 1 shows a perspective view of a rotor of an impact crusher having a plurality of blow bars according to one illustrative embodiment.

FIG. 2 shows a detail view of the arrangement of a blow bar in a rotor according to FIG. 1.

FIG. 3 shows a perspective view of a chock having an application means according to the illustrative embodiment shown in FIGS. 1 and 2.

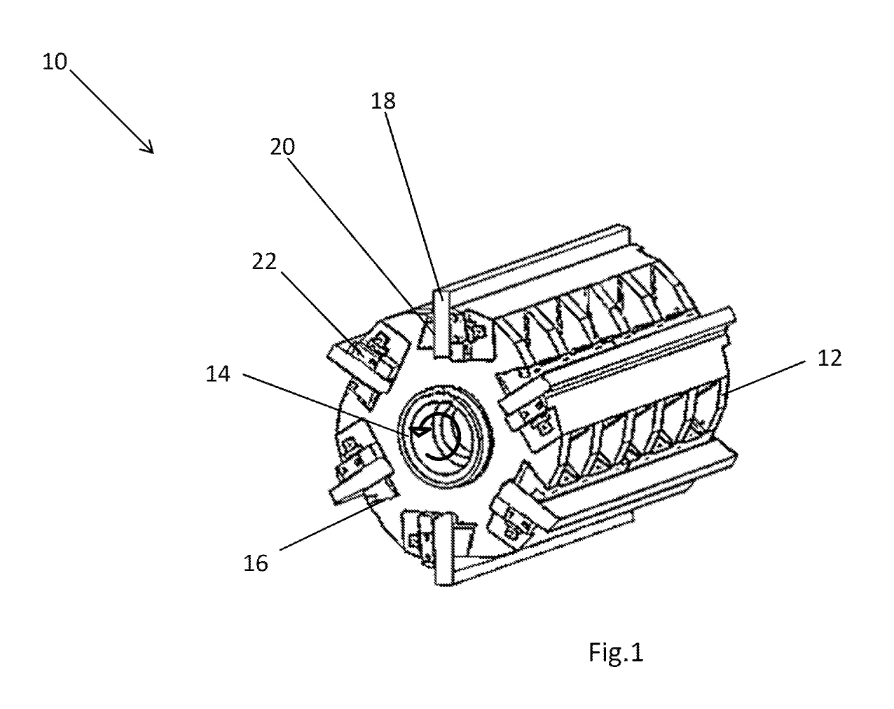

FIG. 1 shows a rotor 10 of an impact crusher for breaking down limestone, marl, clay, rubble or similar mineral materials. The rotor 10 comprises a substantially cylindrical crushing roll body 12 having a central axial hole 14 to receive a shaft (not shown) for driving the crushing roll body 12. During the operation of the impact crusher, the rotor 10 rotates in the direction of the arrow, wherein the blow bars 18 interact, for example, with another rotor (not shown in FIG. 1) rotating in the opposite direction or with impact elements (not shown) arranged to the side of the rotor 10.

On its outer circumference, the crushing roll body 12 has six recesses 16, which extend in the axial direction and in each of which a blow bar 18 and a chock 20 are arranged. The substantially plate-shaped blow bars 18 extend in the axial direction over the entire length of the crushing roll body 12, with the result that they each end at the side faces of the crushing roll body 12. In the radial direction, the blow bars 18 each extend over about a third of their height beyond the outer circumference of the crushing roll body 12 and extend with about two thirds of their height into the crushing roll body 12. The blow bars 18 are arranged spaced apart uniformly over the circumference of the crushing roll body 12. Each blow bar 18 rests against the chock 20 by means of the side face facing in the direction of rotation and against the crushing roll body 12 by means of the opposite side face. Furthermore, fastening means 22, which prevent movement of the blow bars 18 in the axial direction, are mounted on the crushing roll body 12. The fastening means 22 are preferably plates mounted on the side face of the crushing roll body 12, which are, for example, screwed to the crushing roll body 12 and interact with the blow bar 18, ensuring that the blow bar 18 is fixed in the axial direction.

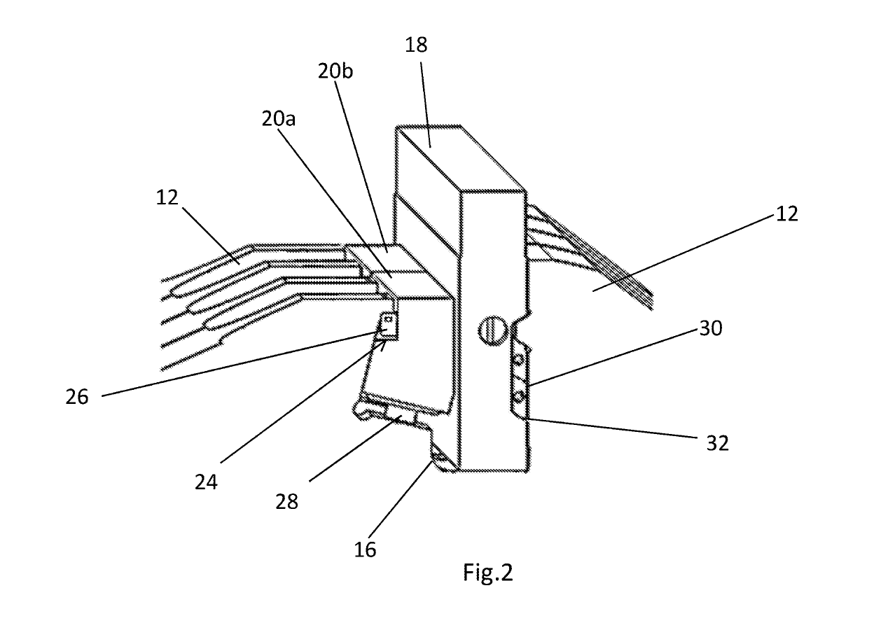

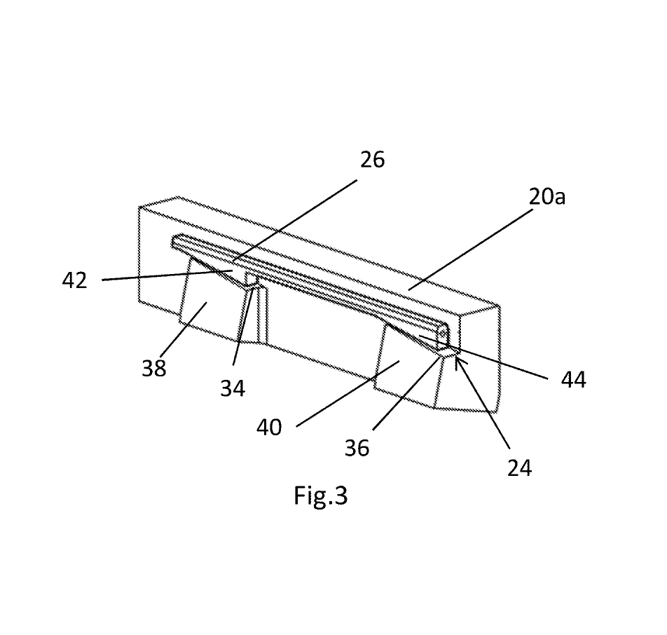

FIG. 2 shows the arrangement of the blow bars 18 in the crushing roll body 12, wherein, by way of example, a blow bar 18 is illustrated in the crushing roll body 12 on an enlarged scale relative to FIG. 1. The fastening means 22 are not shown in FIG. 2 for the sake of simplicity. In FIG. 2, by way of example, the chock 20 comprises a first chock 20a and a second chock 20b, arranged adjacent to the first chock in the axial direction, in the recess 16 in the crushing roll body 12. Each chock 20a and 20b has a receiving region 24, which is arranged on the side face of the chock 20 which faces in the direction of rotation. The receiving region 24 is formed between the chock 20 and the crushing roll body 12 and is described in greater detail with reference to FIG. 3. An application means 26 is arranged in the receiving region 24. The application means 26 is of substantially beam-shaped design with a rectangular cross section and extends in the axial direction, wherein it rests against the chock 20 and the crushing roll body 12. The chocks 20a and 20b rest by means of their side face facing counter to the direction of rotation of the rotor 10 against the blow bar 18. The opposite side face of the chock 20a and 20b, that facing in the direction of rotation, rest by means of a radially inward region against the crushing roll body 12 and by means of the receiving region 24 against the application means 26. The side face of the chock 20a, 20b which rests against the blow bar 18 and the opposite side of the chock 20a, 20b, that resting against the crushing roll body 12, form an angle of about 5-30°, preferably 10-20°, in particular 14°, relative to one another, wherein the chock 20a, 20b tapers in a wedge shape in the radially outward direction.

The chock 20a, 20b furthermore has a plurality of hydraulic cylinders, which are mounted on the radially inward-facing lower side of the chock and rest against the crushing roll body 12 in the recess 16. For example, each chock 20a, 20b has at least two hydraulic cylinders 28, wherein just one hydraulic cylinder 28 is illustrated in FIG. 2.

In the side face facing counter to the direction of rotation, the blow bar 18 has a trapezoidal recess 32, which extends in the axial direction along the length of the blow bar 18. The crushing roll body 12 has a trapezoidal projection, which rests against the blow bar 18 in the recess 32 and has a smaller size, in particular a smaller width, than the recess 32. Arranged in the recess 16 in the crushing roll body 12 is a supporting device 30, which has two support bars. The support bars are arranged adjacent to the trapezoidal projection, further inward in the radial direction, in the recess 32 and support the trapezoidal projection in the radial direction, with the result that the blow bar is fixed radially on the crushing roll body 12. The support bars extend in the axial direction, along the length of the blow bar, in the recess 32.

FIG. 3 shows a detail view of a chock 20a having an application means 26 in accordance with FIG. 2. The structure of the second chock 20b (not shown in FIG. 3) corresponds symmetrically to the first chock 20a, and therefore only the first chock 20a is explained by way of example with reference to FIG. 3. The receiving region 24 of chock 20a has two projections, which are arranged along the side face of the chock 20a which faces in the direction of rotation. The projections are of substantially the same height and each comprise a contact surface 34, 36, against which the application means 26 rests. The contact surfaces 34, 36 comprise the radially outward-facing surfaces of the projections, wherein these have a slope angle of about 5-20°, preferably 5-10°, in particular 8°, to the axial direction. The surfaces 38, 40 of the projections which face in the direction of rotation form an angle of about 5-30°, preferably 10-20°, in particular 14°, to the opposite surface facing counter to the direction of rotation, and therefore chock 20a is of wedge-shaped design in the radially outward direction. Arranged in the receiving region 24 is the application means 26, which is of substantially beam-shaped design and extends along the side face of chock 20a which faces in the direction of rotation. The application means 26 is shorter than chock 20a and does not extend beyond chock 20a. The application means 26 has two wedge-shaped bearing regions 42, 44, which rest by means of their radially inward-facing surfaces against the contact surfaces 34, 36. The radially inward-facing surfaces of the wedge-shaped bearing regions 42, 44 have a slope designed to match the contact surfaces 34, 36 of about 5-20°, preferably 5-10°, in particular 8°, to the axial direction. The bearing regions 42, 44 are of wedge-shaped design in the axial direction, in particular in the axial direction toward the adjacent chock 20b.

During the operation of the rotor 10, said rotor rotates in the direction of the arrow, wherein material is broken down at the blow bars 18. The blow bars 18 are fastened in a respective recess 16 in the crushing roll body 12 by movement of the chock 20 in the radially outward direction by means of the hydraulic cylinders 28. The wedge shape of the chock 20 brings about wedging of the chock 20 between the crushing roll body 12 and the blow bar 18 within the recess 16. In the wedged state of the chock, the application means 26 rests against the crushing roll body 12 and the chock 20 and does not affect the fastening of the blow bar 18 in the wedged state.

To replace or radially adjust the blow bar 18, the chock 20 is released from the wedged state by first of all retracting the hydraulic cylinders in the radial direction. To apply a radially inward force to the chock, the application means 26 is moved in the axial direction, in particular counter to the wedge shape of the bearing regions 42, 44. By virtue of the wedge-shaped design of the bearing regions 42, 44, the chock 20 is acted upon by a radially inward force when the application means is moved axially counter to the wedge shape, with the result that the wedging of the chock 20 in the recess 16 is released. To move the application means 26 in the axial direction, it is moved manually by means of hammer blows, for example. For this purpose, a worker strikes the application means laterally with respect to the rotor 10 and releases the wedging of the chock. The movement of the application element 26 can furthermore be accomplished mechanically, hydraulically or electrically.

After the wedging has been released, the blow bar 18 can be moved in the radial direction and turned around or radially offset, for example. For radial offsetting, the support bars of the supporting device 30 are removed, and the blow bar 18 is moved into the corresponding radial position. The support bars are then arranged appropriately in the recess 32, adjacent to the projection of the crushing roll body 12. The blow bar 18 can be fixed in three different radial positions by means of the supporting device 30 shown by way of illustration.

A rotor 10 with the construction described above enables the blow bar 18 to be released in a simple manner from the state in which it is wedged with the chock 20, wherein a radially inward force is applied to the chock in a simple manner by means of the application means 26. Opening a housing mounted around the rotor to release the chock is not necessary since the application means is accessible from the side of the rotor and only a force in the axial direction is required to move the chock in the radial direction.

### LIST OF REFERENCE NUMERALS

10 Rotor
12 Crushing roll body
14 Hole
16 Recess
18 Blow bar
20 Chock
20a First chock
20b Second chock
22 Fastening means
24 Receiving region
26 Application means
28 Hydraulic cylinder
30 Supporting device
32 Recess in the blow bar
34 Contact surface
36 Contact surface
42 Bearing region
44 Bearing region

1.-12. (canceled)

13. A rotor of an impact crusher comprising:
a crushing roll body that is rotatable about a center line of the crushing roll body, wherein the crushing roll body includes a radial recess;
a blow bar disposed in the radial recess of the crushing roll body; and
a chock disposed in the recess between the blow bar and the crushing roll body, wherein the chock includes a receiving region in which an application means for moving the chock in a radially-inward direction is disposed, wherein the application means is configured such that when the application means is moved in an axial direction along the chock the application means applies a radially-inward force to the chock.

14. The rotor of claim 13 wherein the application means is at least partially wedge shaped.

15. The rotor of claim 13 wherein the receiving region extends in the axial direction along the chock.

16. The rotor of claim 13 wherein the application means extends in the axial direction.

17. The rotor of claim 13 wherein the application means rests against the crushing roll body and the chock.

18. The rotor of claim 13 wherein the receiving region includes a contact surface against which the application means rests, wherein the contact surface forms an angle of 5°-10° with respect to the axial direction.

19. The rotor of claim 13 wherein the receiving region includes a contact surface against which the application means rests, wherein the contact surface forms an angle of 5°-20° with respect to the axial direction.

20. The rotor of claim 19 wherein the receiving region on the chock comprises a projection on which the contact surface is disposed.

21. The rotor of claim 13 wherein the chock has a wedge angle in a range of 5° to 30°.

22. The rotor of claim 13 wherein the chock has a wedge angle in a range of 10° to 20°.

23. The rotor of claim 13 further comprising an actuating element for moving the application means in the axial direction, the actuating element being mounted on the application means.

24. The rotor of claim 13 wherein the actuating element is of a mechanical design, an electrical design, or a hydraulic design.

25. The rotor of claim 13 wherein the blow bar comprises a trapezoidal recess and the crushing roll body comprises a trapezoidal projection that rests at least partially in the trapezoidal recess of the blow bar.

26. The rotor of claim 13 wherein the blow bar comprises a recess and the crushing roll body comprises a projection that rests at least partially in the recess of the blow bar.

27. The rotor of claim 26 further comprising a supporting device that has a support bar and is disposed in the recess of the blow bar adjacent to the projection to fix the blow bar in a radial direction.
